(19) United States
(12) Patent Application Publication
(10) Pub. No.: US 2009/0319232 A1
(43) Pub. Date: Dec. 24, 2009

(54) DEVICE AND PROCESS FOR MONITORING AND DIAGNOSIS OF THE STATE OF A MACHINE, MACHINE COMPONENT OR SYSTEM

(75) Inventors: Erich GRIESSLER, Schechen (DE); Michael DANITSCHEK, Schwaz (AT)

Correspondence Address: ROBERTS MLOTKOWSKI SAFRAN & COLE, P.C.;Intellectual Property Department, P.O. Box 10064, MCLEAN, VA, 22102-8064, US

(73) Assignee: i-for-T GmbH, Rosenheim (DE)

(21) Appl. No.: 12/490,894

(22) Filed: Jun. 24, 2009

(30) Foreign Application Priority Data
Jun. 24, 2008 (DE) 10 2008 029 672.4

(51) Int. Cl. G06F 15/00

(52) U.S. Cl. 702/184; 702/183

(57) ABSTRACT

A device for monitoring and diagnosis of the state of a machine, machine component or system, with a housing (4), with a measured value detection unit (5) for detecting measured values supplied by at least one sensor (6) which is connected to the machine, machine component, or system, with a communications unit (7) for reading in process or operating data of the machine, machine component, or system, with an evaluation unit (8), which determines at least one value which characterizes the state of a machine (2), machine component (3), or system based on measured values delivered by the measured value detection unit (5) and process and operating data which have been read in by the communications unit (7), with a storage unit (9), with a communications unit (7) for outputting measured values, process or operating data and/or values computed by the evaluation unit (8), and with a display (10).

### BACKGROUND OF THE INVENTION

1. Field of Invention

The invention relates to a device for monitoring and diagnosis of the state of a machine, machine component or system, with a housing, with a measured value detection unit for detecting measured values which are supplied by at least one sensor which is connected to a machine, machine component, or system, with an evaluation unit, with a storage unit, with a communications unit for outputting the values computed from the evaluation unit and with a display.

2. Description of Related Art

Moreover, the invention relates to a process for monitoring and diagnosis of the state of a machine, machine component or system, with a device which has a measured value detection unit, at least one communications unit, an evaluation unit, a storage unit and a display, as well as an arrangement of a corresponding device and of a sensor which is connected to the device by way of a wireless or a wired connection.

The initially described device is known from German Patent DE 102 28 389 B4 in the form of a vibration sensor. The vibration sensor is used here especially for monitoring the state of rotating components or bearings, in the known vibration sensor within the housing there being a sensor element. The known vibration sensor which has a very compact construction is attached directly to the machine or system which is to be monitored so that the sensor element can detect the vibrations transmitted by way of the housing.

In the known vibration sensor, in the evaluation unit a plurality of signals which have been detected by the sensor element using signal analysis and a diagnosis algorithm are converted into a state value which reproduces the state of the monitored bearing and which can be directly displayed on the display of the vibration sensor. By way of a switching output which is made on the vibration sensor, also the state of the bearing can be sent to a remote location, for example, a central monitoring site. Based on the transmitted state value, a maintenance measure, for example, repair or replacement of a bearing, can be initiated at the central monitoring unit.

Until a few years ago maintenance took place for machines, machine components, or systems either as so-called preventative maintenance, in which machines, machine components and systems are maintained at regular intervals and machine parts are replaced as a precaution, or as reactive (failure-dictated) maintenance in which the occurrence of problems or failures is awaited which only then entail maintenance measures. By using intelligent sensors which can monitor the state of the machine, machine component or system, state-oriented maintenance can be performed. In this connection, faults will be recognized early such that downtimes are minimized as much as possible. At the same time machines, machine components and systems will only be maintained, repaired or replaced as possible if such is actually required. Due to higher and higher requirements for productivity and system capacity utilization, the choice of the corresponding maintenance strategy is acquiring increasing importance.

The basis for implementation of state-oriented maintenance is automatic monitoring of machine states by sensors which measure physical quantities which are directly or indirectly linked to the operating state of the machine, machine component or system. These sensors are often also called condition monitoring sensors, based on their function. The measurement data supplied by these sensors—as pure measured values or as combined features—are typically relayed by way of different communications levels as far as to central operating data detection or to the process information system (control center). Only on this level are the incoming measurement data then monitored and transferred to trend analysis which enables a conclusion about the change of state. Here, process and operating data such as rpm, loads or temperatures which are generally delivered from the machine control or system control and are not present on the sensor level, are also considered in the assessment of the state.

If, in central operating data detection or in the process information system, a relevant state change is detected, a corresponding maintenance process can be started. Here, in the maintenance department, the corresponding processes, such as repair requests, orders and messages are drawn up by hand or by way of its own corresponding software, and when the work is completed, corresponding completion is documented. After completion of the maintenance measure, then an acknowledgement to the control center must take place so that monitoring of the state of the machine or system can be activated again there.

On the level of operating data detection, generally, a storage function is implemented which stores all state data in order to later be able to ascertain and prove within the framework of analysis, the causes and origination of the damage that resulted in a failure of the machine or machine component. If a machine component has to be repaired, generally dismounting of the component takes place, a corresponding replacement component being installed when the damage cannot be promptly corrected on site. The defective machine component is generally sent back to the manufacturer in order to carry out cause analysis and repair of the component there. The problem in this connection is that the state data stored only in the central operating data detection and the relevant process and operating data of the defective machine or machine component are not generally available to the component manufacturer.

### SUMMARY OF THE INVENTION

Therefore, a primary object of this invention is to further improve the initially described device and the process for monitoring the state and diagnosing the state of a machine, machine component or system such that decentralized state monitoring and state diagnosis of a machine, machine component or system are possible, and preferably, the assignment of the relevant state data and process and operating data are easily ensured for the respective machine, machine component, or system.

This object is achieved in accordance with the invention by a device in which not only are the measured values delivered by at least one sensor, but additionally by way of the communications unit, for example, from the control of the machine or system, also the respective process and operating data are transmitted to the device or evaluation unit so that the evaluation unit with consideration of the measured values delivered by the measured value detection unit and the process and operating data which have been read in by the communications unit can determine at least one value which characterizes the state of the machine, machine component or system.

In this way, not only pure state-oriented maintenance, but a combined state-oriented and performance-referenced maintenance is possible. When—as in the prior art—on the level of the machine or machine component only the measured values delivered by a sensor are considered for state monitoring, only changes of the measured values, but not changes of the process or operating data, can be considered.

Because all values and data required for assessment of the state and for determination of a state diagnosis can be made available to the device, all data which are necessary for later evaluation and analysis of machine damage can be locally stored in the device. These data can then be made available as necessary to the manufacturer of the machine or machine component to be repaired without the higher-order central operating data detection or process data information system being necessary for this purpose access.

According to one advantageous embodiment, in the device in accordance with the invention the communications unit for reading in the process or operating data and the communications unit for outputting measured values, process or operating data and/or values which have been computed by the evaluation unit are implemented by a common, bidirectional communications unit. Instead of two separate communications units, thus only one communications unit is necessary, by way of which both data can be read in and also output.

The device in accordance with the invention can be made such that, by way of the measured value detection unit, the measured values of several sensors, for example, up to four sensors, can be detected. The individual sensors can be connected either by way of a wireless or a wired connection to the measured value detection unit, of course, it also being possible for each sensor to be assigned its own measured value detection unit.

Especially when the device in accordance with the invention is connected to a sensor which delivers high frequency signals, for example, a vibration sensor, it is advantageous if frequency-selective feature formation takes place in the evaluation unit. In the evaluation unit the measured values delivered from the measured value detection unit are converted into a feature which characterizes the operating state of the machine, machine component and system using measured value analysis and a diagnosis algorithm. The measured value analysis takes place preferably both in the time domain and also in the frequency domain, as is described for example, in German Patent DE 102 28 389 B4 with respect to the vibration sensor disclosed there.

According to another advantageous configuration of the device in accordance with the invention, in the evaluation unit, the process or operating data which have been read in from the communication unit and which, for example, are delivered from the control of the machine or system are monitored with respect to a state change. Since, in the device in accordance with the invention, not only the measured values delivered by the measured value detection unit, but also the process or operating data read in from by the communications unit are used for monitoring and diagnosis of the state of the machine, machine component or system, a change of the value which characterizes the state and which is determined by the evaluation unit can also take place when only the process or operating data have been changed, but not or not yet the empirical values measured by the sensor. In this way the circumstance is considered that a measured value, for example, at a first rpm constitutes a noncritical state, but for a second higher rpm can mean a critical state of the machine.

According to another configuration of the device in accordance with the invention, from the evaluation unit the operating time, the operating performance or the residual operating time of a monitored machine, machine component or system are also computed by the evaluation unit. Preferably the operating time, the operating performance or the residual operating time are computed for different process or operating data, i.e., performance-referenced. In this connection, the circumstance is also considered that a certain measured value under certain circumstances necessitates different maintenance measures, depending on how long a machine has already been in operation.

As was already stated at the beginning, the device in accordance with the invention also has a display so that the operating state of the machine, machine component or system can be viewed directly on site by means of the display. Moreover, the display can also show the operating time, the operating performance or the residual operating time and the possible necessity of a maintenance measure and the respective maintenance measure. For this purpose, the display can be made either as an alphanumeric display or as a symbolic display or bar display; of course, it also possible that, in addition to an alphanumeric display in the form of a seven-segment display or a LCD display, there is, for example, a bar display. In particular, display of the necessity of a maintenance measure can also be especially easily and still uniquely implemented by a color display, especially with the colors green, yellow and red.

In addition to local display of the determined values and features, it is also provided that these values and features are output by way of the communications unit. In this connection, output is possible both to a high-order control or central operating data detection or a control center as well as to a storage connected to the machine, machine component or system. Moreover, the device can also have a separate alarm interface by way of which the necessity of a maintenance measure can be directly relayed. Possibly, the emergency turning off of a machine can also be implemented in this way.

If the features which characterize the operating state of the machine, machine component or system and the relevant operating and process data are transmitted to a storage which is connected to the machine, machine component or system, in this way, it is easily ensured that the information necessary for damage assessment is directly available to the machine manufacturer for repairing of the machine or machine component. Here, the storage can also be integrated in the sensor. The communications unit or evaluation unit can be made such that the storage assigned to one machine or machine component at a time receives only the relevant information relating to this machine or machine component.

According to another advantageous embodiment of the device in accordance with the invention, the storage unit is made such that the process or operating data which have been read in by way of the communications unit, the measured values which have been detected by the measured value detection unit, or the features and characteristic values which are determined by the evaluation unit can be stored in their time behavior. In this case, the individual data, measured values and features are stored preferably in different storage intervals, the duration of the individual storage interval and the number of data and values stored within the individual storage interval can be freely adjusted or can be configured relative to the event. This can result in that, for critical and changing operating states, a larger number or density of data and values is stored than for noncritical operating states which do not change, by which a reduction of the stored data and values to the “relevant” data and values takes place.

The later evaluation and analysis of damage of a machine or machine component which has occurred can also be further facilitated in that the storage unit according to another advantageous configuration of the invention can be removed from the housing of the device. The storage unit can be, especially, an external data storage, for example, a USB stick (flash or thumb drive) or a compact flash card. This also makes it possible to easily deliver the relevant information to the machine manufacturer for analysis and evaluation of machine damage which has occurred.

In order to further facilitate evaluation and analysis of machine damage, it is moreover advantageously provided that the data from the evaluation unit which are stored in the storage unit are provided with a time stamp. For this purpose, the device has a real time clock which is connected to the evaluation unit. Thus, the process and operating data which have been submitted before machine damage occurs can be uniquely reconstructed.

In the initially described process, the object is achieved in accordance with the invention by the following steps, of which the first two steps also can be carried out in the reverse sequence or at the same time:
the measured value detection unit detects measured values which are delivered from at least one sensor which is connected to the machine, machine component or system;
the communications unit reads in the process or operating data of the machine, machine component or system;
the evaluation unit, with consideration of the measured values delivered from the measured value detection unit and the process or operating data read in from the communications unit, determines at least one value which characterizes the state of the machine, machine component or system.
the value determined by the evaluation unit is output by way of the communication unit and/or displayed on the display and/or stored in the storage unit.

With respect to the advantages of the process, reference is made to the aforementioned with respect to the device in accordance with the invention. Advantageously, in the process in accordance with the invention, the value determined by the evaluation unit is stored in the storage unit and is both output via the communications unit and also displayed on the display.

According to one especially preferred configuration of the process in accordance with the invention, the detected measured values, process data or operating data and the determined values or features are additionally filed in a storage located in the sensor. In this connection they are preferably measured values, for example, peak values or counter contents provided with a time stamp, or process data or operating data, for example, initial values in the start-up of the sensor or machine which are assigned to the respective sensor or respective machine.

The initially described object is finally achieved by an arrangement of a device for monitoring and diagnosis of the state of the machine, machine component or system, a sensor and a storage unit, both the sensor and also the storage unit being connected to the device by way of a wireless or wired connection. At least one physical quantity is measured by the sensor and transmitted by way of the measured value detection unit to the evaluation unit of the device which is directly or indirectly connected to the operating state of the machine, machine component or system to be monitored. With consideration of the measured values delivered from the measured value detection unit and of the process and operating data which are read in from the communications unit, the evaluation unit determines a value which characterizes the state of the machine, machine component or system which can be transmitted to the storage element by way of the communications unit. The storage element can be assigned either to the machine, machine component or system. Preferably the storage element is assigned to the sensor.

In the arrangement in accordance with the invention, thus the measured values detected by the sensor which are assigned to the machine are transmitted to the device and characteristic values determined by the device from the measured values and other data are transferred to a storage unit which is likewise connected to the machine or the sensor. This ensures that in case of damage, when the machine is being replaced, the information necessary for damage analysis and damage assessment are available locally on the machine.

Preferably, the storage element is integrated in the sensor so that the storage element is part of the sensor. In this regard, then the connection between the sensor and the storage element on the one hand and the device on the other can be implemented by a common wired connection.

In particular, there are now a plurality of possibilities for embodying and developing the device, process and arrangement in accordance with the invention as will be apparent from the following description of a preferred embodiment in conjunction with the accompanying drawings.

### BRIEF DESCRIPTION OF THE DRAWINGS

FIG. 1 is a schematic block diagram of a device according to the invention,

FIG. 2 is a schematic block diagram of an arrangement formed of several machine components, and the device of the invention, and

FIG. 3 is a schematic block diagram of a sensor of the arrangement shown in FIG. 2.

### DETAILED DESCRIPTION OF THE INVENTION

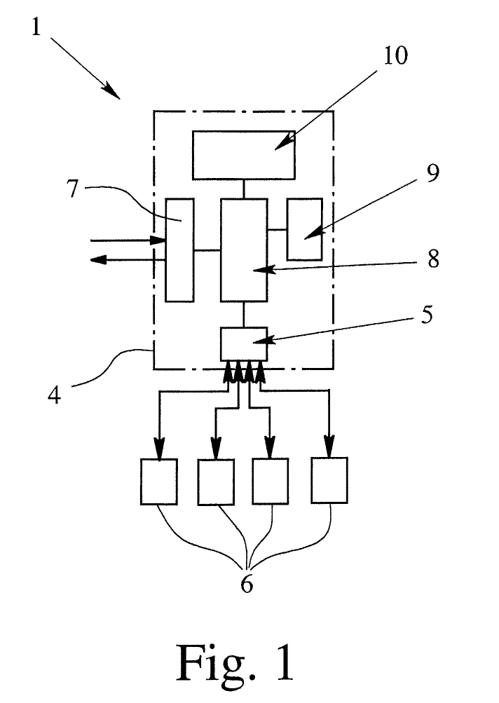

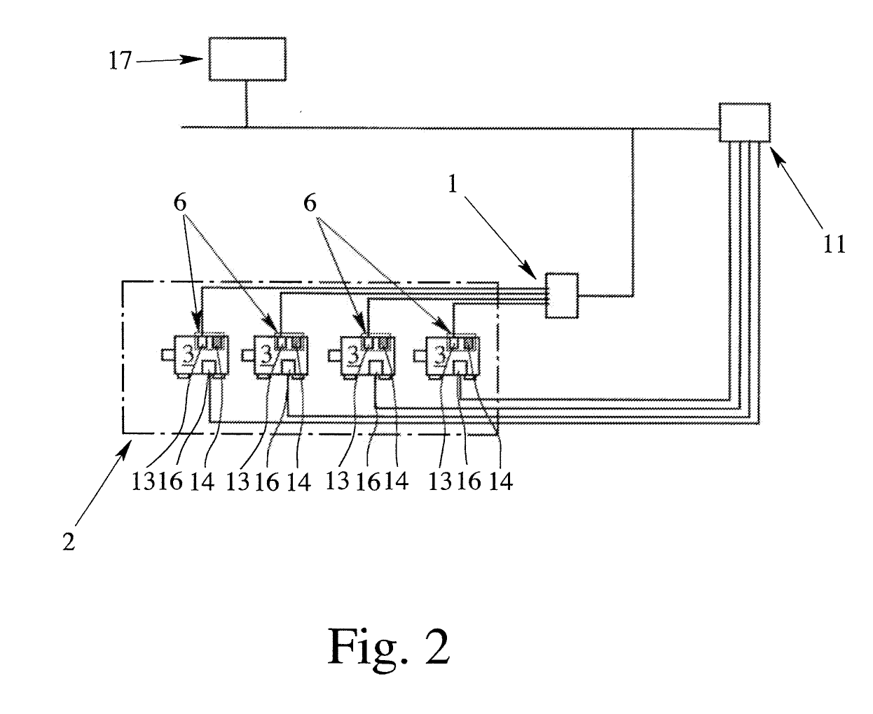

FIG. 1 shows the device 1 for monitoring and diagnosis of the state of a machine 2, shown schematically in FIG. 2, for example, a machine tool, with several machine components 3, for example, several tool spindles, a rotating table spindle or a lubricating coolant pump.

The device 1 has a housing 4 which protects the components located within, which surrounds it, and which, for example, has a fastening or mounting foot so that the housing 4 can be attached directly to the machine 2 and can be locked onto a mounting rail.

The device 1 has a measured value detection unit 5 for detecting the measured values which are delivered from the individual sensors 6 which are connected to the machine component 3 according to the embodiment in FIG. 2. If the machine components 3 are workpiece spindles or rotating table spindles, the sensors 6 can be vibration sensors or rpm sensors. For a lubricating coolant pump the sensors 6 can be, for example, a temperature sensor or a pressure sensor. The measured value detection unit 5 which is made according to the embodiment in FIGS. 1 & 2 for detecting the measured values by up to four sensors 6, has especially an interface with a number of analog/digital converters which corresponds to the number of connectable sensors 6. If a sensor 6, which is connected to the device 1 by way of the measured value detection unit 5, is made such that it delivers a digital signal as the output signal, the use of an analog-digital converter in the measured value detection unit 5 can be eliminated.

Moreover, the device 1 has a communications unit 7 which is made, in this embodiment, like the measured value detection unit 5 as a bidirectional interface so that, by way of the communications unit 7, signals can be both read in and also output. Additionally, the device 1 according to the schematic in FIG. 1 has an evaluation unit 8, a storage unit 9 and a display 10, the evaluation unit 8 for example, being implemented by a microprocessor and being connected to the other components, specifically the measured value detection unit 5, the communications unit 7, the storage unit 9 and the display 10.

In particular, the process and operating data originating from the control 11 of the machine 2 can be read in by way of the communications unit 7 and are considered in the evaluation unit 8, as can the measured values delivered from the sensors 6 in the determination of a value which characterizes the state of the machine 2 or the machine components 3. Fundamentally the measured values delivered from the sensors 6 can also be read in by way of the communications unit 7—alternatively or additionally to the measured value detection unit 5. Moreover, by way of the communications unit 7 information and data, especially a state value determined by the evaluation unit 8 or an alarm signal, can be output and thus transferred to higher-order operating data detection or a control center.

The control 11 is preferably a SPS (programmable logic controller PLC) or a PC to which other sensors 16 which are located on the machine components 3 are connected. The other sensors 16 which are used to obtain process and operating data can be for example, temperature sensors. The connection between the communications unit 7 and the control 11 takes place by way of a local area network (LAN), preferably over Ethernet or Fast Ethernet, over which a master computer or control center 17 and other controls can be connected.

The storage unit 9 stores all relevant data about the current state of the individual machine components 3 and the process and operating data and their respective duration of action, the stored data preferably from the evaluation unit 8 being provided with a time stamp. The storage unit 9 which can be a data storage which can be removed from the housing 4 thus constitutes a history storage using which in the case of damage which has occurred on a machine component 3 and displayed by the device 1 exact analysis of the cause can be carried out.

Especially the operating state of the machine 2 or a machine component 3 can be displayed directly on site by way of the display 10 provided in the device 1. Moreover, a required maintenance measure, and for example, the remaining operating time of the affected machine component 3 determined by the evaluation unit 8 can also be directly displayed on the display 10. In addition to a LCD display or a 7-segment display, the display 10 can, in particular, also have a color display by means of which especially when using the colors green, yellow and red the current state of the machine 2 or machine component 3 can be displayed in an easily detectable manner.

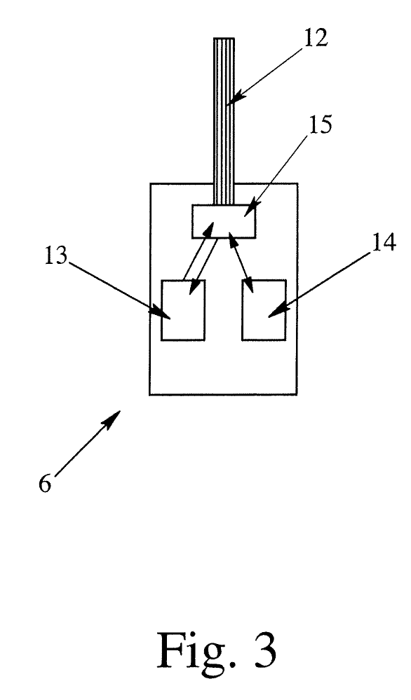

FIG. 3 shows a schematic block diagram of a sensor 6 which is connected by way of a wired connection 12 to the device 1, especially the measured value detection unit 5. Here, the sensor 6, in addition to the actual measurement transducer 13, has a storage unit 14 in which, by way of a wired connection 12, relevant data of the machine component 3 which is assigned to the sensor 6 can be stored. The data are especially the features and characteristic values determined by the evaluation unit 8 and the process and operating data relevant for the machine component 3. These data can be transmitted at a fixed instant, for example, in the evening or for certain events from the storage unit 9 of the device 1 to the storage element 14. Moreover the sensor 6 has an interface 15 by way of which both the measurement transducer 13 and also the storage element 14 are connected to the wired connection 12. The interface 15 can be, for example, a PIC controller [programmable interrupt controller].

In the sensor 6 which is shown in FIG. 3, thus, the measured values detected by the measurement transducer 13 can be transmitted via the interface 15 and the connection 12 to the device 1 and features and characteristic state values determined by the device 1 and the evaluation unit 8 and the process and operating data stored in the storage unit 9 from the device 1 can be stored by way of the connection 12 and the interface 15 in the storage element 14.

In the case of service, then, all the relevant data relating to the machine component 3 to be repaired are present directly on site, specifically in the storage element 14. For the case in which the sensor 6, in case of service, does not remain on the machine component 3 which is to be replaced, the storage element 14 can also be made as a reversible storage element which is then removed from the sensor 6 and is made available to the manufacturer with the machine component 3. However, preferably, the storage element 14, as shown in FIGS. 2 & 3, is made as a part of the sensor 6.

If, for example, a tool spindle 3, as a component of a machine tool 2, is running over a long time interval at an elevated operating temperature, this is measured by way of the temperature sensor 16 and is recorded in the control 11. This information is read in from the device 1 by way of the communications unit 7 and transmitted as a cumulative value by way of the measured value detection unit 5 to the sensor 6 where the value is stored in the storage element 14. If the tool spindle 3 fails so that it must be repaired at the manufacture or an external repair service, the latter can read out the information that the tool spindle 3 had been running over a long time interval at an elevated operating temperature from the storage element 14 of the sensor 6. Based on this information—possibly together with other information stored in the storage element 14 or in the storage unit 9 of the device 1—the manufacturer or repair service can then more accurately ascertain what led to the failure of the tool spindle 3.

The wired connection 12 can be comprised of several lines, for example, four lines, of which at least one can be made bidirectional. By way of this line, alternatively, data which have been detected by the interface 15 can be written into the storage element 14 (write data mode) or data can be read out from the storage element 14 and can be erased if necessary (read data mode). The storage element 14 is then made as an EEprom. Transmission over the connection takes place from the sensor 6 to the device 1, preferably in analog form, while transmission from the device 1 to the sensor 6 takes place preferably digitally. Moreover, by way of the bidirectional line, in a second function, a self-test of the measurement transducer 13 can also be triggered so that this bidirectional line acts as a self-test line.

What is claimed is:

1. Device for monitoring and diagnosis of the state of a machine, machine component or system, comprising:
a housing,
at least one sensor for connection to a machine, machine component, or system,
a measured value detection unit for detecting measured values which are supplied by said at least one sensor,
a communications unit for reading in process or operating data of the machine, machine component, or system to which the at least one sensor is connected in use,
an evaluation unit which, based on measured values delivered by the measured value detection unit and the process and operating data which have been read in by the communications unit, determines at least one value which characterizes the state of the machine, machine component, or system,
a storage unit for storing at least one of measured values, process and operating data, and values computed by the evaluation unit,
an output unit for outputting at least one of measured values, process and operating data, and values computed by the evaluation or stored values and data, and
a display.

2. Device in accordance with claim 1, wherein the communications unit for reading in the process or operating data and the output unit for outputting at least one of measured values, process and operating data, and values computed by the evaluation unit are formed of a common, bidirectional communications unit.

3. Device in accordance with claim 1, wherein the evaluation unit is adapted to determine occurrence of a state of the machine, machine component or system requiring a maintenance measure, and in response thereto, is adapted to display the maintenance measure required on the display and to output it by way of the communications unit.

4. Device in accordance with claim 1, wherein the evaluation unit is adapted to convert measured values delivered from the measured value detection unit into a characterization of the operating state of the machine, machine component and system.

5. Device in accordance with claim 1, wherein the evaluation unit is adapted to monitor changes of process and operating data obtained from the communications unit, said data being at least one of rpm, load, temperature and pressure.

6. Device in accordance with claim 1, wherein the evaluation unit is adapted to compute at least one of operating time, operating performance and residual operating time of a monitored machine, machine component or system.

7. Device in accordance with claim 6, wherein the display is adapted to display said at least one of the operating time, the operating performance and the residual operating time, in the form of at least one of an alphanumeric display, a symbolic display and a bar display.

8. Device in accordance with claim 6, wherein the communications unit is adapted for outputting said at least one of the operating time, the operating performance and the residual operating time to the storage element.

9. Device in accordance with claim 1, wherein the communications unit is a replaceable unit and the evaluation unit is adapted to determine the type of communications unit installed.

10. Device in accordance with claim 1, wherein the storage unit is also adapted to store data from at least one of the communications unit, the measured value detection unit and the evaluation unit as a function of time.

11. Device in accordance with claim 10, wherein in the storage unit is adapted for storing data in different storage intervals, the duration of the individual storage intervals, and the number of data and values which can be stored within the storage intervals being freely adjustable.

12. Device in accordance with claim 11, further comprising a real time clock which is connected to the evaluation unit and wherein the evaluation unit is adapted to provide the data stored in the storage unit with a time stamp.

13. Device in accordance with claim 1, further comprising an alarm interface.

14. Process for monitoring and diagnosis of the state of a machine, machine component, or system with a device which has a measured value detection unit, at least one communications unit, an evaluation unit, a storage unit and a display, comprising the steps of:
detecting measured values which are supplied by at least one sensor which is connected to the machine, machine component or system with the measured value detection unit, using the communications unit to read in process or operating data of the machine, machine component or system,
using the evaluation unit to evaluate measured values delivered by the measured value detection unit and the process or operating data which have been read in by the communications unit to determine a value which characterizes the state of a machine, machine component, or system,
outputting the value determined by the evaluation unit to at least one of the communications unit and the display and/or stored in the storage unit.

15. Process in accordance with claim 14, wherein, based on the value determined by the evaluation unit, the evaluation unit determines the necessity of a maintenance measure and at least one of displays it on the display and outputs it by way of the communications unit.

16. Process in accordance with claim 14, wherein the evaluation unit converts the measured values delivered from the measured value detection unit into a feature which characterizes the operating state of the machine, machine component and system using measured value analysis and a diagnosis algorithm.

17. Process in accordance with claim 14, wherein the evaluation unit monitors at least one of changes of process and operating data obtained from the communications unit and changes of measured values obtained from the measured value detection unit.

18. Process in accordance with claim 14, wherein the evaluation unit computes at least one operating time, operating performance and residual operating time of a monitored machine, machine component or system.

19. Process in accordance with claim 14, wherein the storage unit stores at least one of process or operating data read in by way of the communications unit, measured values which have been detected by the measured value detection unit, and values which have been determined by the evaluation unit in different storage intervals, and at least one of the duration of the individual storage intervals and the amount of data and values stored within the storage intervals being freely adjusted.

20. Process in accordance with claim 14, wherein the values determined by the evaluation unit are transmitted by way of the communications interface to a storage element which is assigned to the machine, the machine component or the system.

21. Process in accordance with claim 14, wherein a sensor which is connected to the machine, machine component or system is subjected to a self-test, the self-test being initiated by the evaluation unit, and the result of the self-test being stored in the storage unit.

22. Arrangement of a device which has a measured value detection unit, at least one communications unit, an evaluation unit, a storage unit and a display for monitoring and diagnosis of the state of a machine, machine component or system, and a sensor which is connected to the measured value detection unit of the device by way of a wireless or wired connection and which measures at least one physical quantity which is linked to an operating state of the machine, machine component or system,
wherein
the evaluation unit, based on measured values delivered by the measured value detection unit and process and operating data which provided by the communications unit, is adapted to determine at least one value which characterizes a state of a machine, machine component, or system,
wherein a storage element which is assigned to at least one of the machine, the machine component or system and the sensor is connected to the communications unit in a manner enabling the at least one value determined by the evaluation unit to be transmittable by the communications unit to the storage element.

23. Arrangement in accordance with claim 22, wherein the sensor and the storage element are connected to the device by way of a common wired connection.

24. Arrangement in accordance with claim 22, wherein the storage element is integrated in the sensor.

25. Arrangement in accordance with claim 22, wherein the storage element is a permanent part of the machine, machine component or system so as to be replaced therewith.
